(19) United States
(12) Patent Application Publication
(10) Pub. No.: US 2006/0163236 A1
(43) Pub. Date: Jul. 27, 2006

(54) Combined changing pad/textile warmer apparatus

(76) Inventors: Brad K. Mazon, Ebenezer, NY (US); Merry Riehm-Constantino, Buffalo, NY (US)

Correspondence Address: HODGSON RUSS LLP, ONE M & T PLAZA, SUITE 2000, BUFFALO, NY, 14203-2391, US

(21) Appl. No.: 11/338,441

(22) Filed: Jan. 24, 2006

Related U.S. Application Data
(60) Provisional application No. 60/646,390, filed on Jan. 24, 2005.

(51) Int. Cl. H05B 1/00

(52) U.S. Cl. 219/217

(57) ABSTRACT

A combination changing pad/textile warmer apparatus that provides a warmed changing surface for changing a baby while also providing a means to warm pajamas, slippers, baby blankets, or the like.

### CROSS-REFERENCE TO RELATED APPLICATION

The present application claims the benefit of U.S. Provisional Patent Application No. 60/646,390 filed on Jan. 24, 2005, which is incorporated herein by reference.

### FIELD OF INVENTION

The present invention relates to heating products.

### BACKGROUND OF THE INVENTION

There is a need for a product that can be used to provide a warmed changing surface for changing a baby while also providing a means to warm pajamas, slippers, baby blankets or the like, in order to eliminate the uncomfortable feeling associated with wearing or using these items in their colder state.

### SUMMARY OF THE INVENTION

The present invention meets the above-described need by providing an electrically-operated heating device that is capable of providing a warmed changing surface while heating items such as pajamas, slippers or the like.

### BRIEF DESCRIPTION OF THE DRAWINGS

The invention is illustrated in the drawings in which like reference characters designate the same or similar parts throughout the figures of which:

FIG. 1 is a perspective view of a combined changing pad and blanket warming apparatus as shown in an embodiment of the present invention; and

FIG. 2 is an enlarged perspective view of the feature control unit of the present invention.

### DETAILED DESCRIPTION

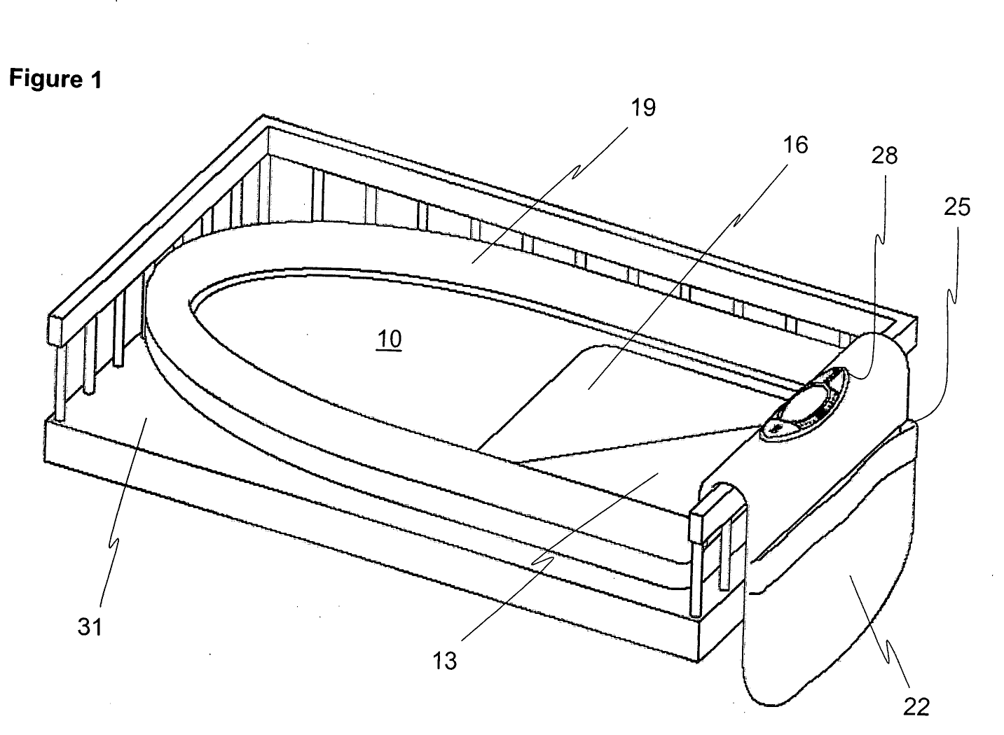

Referring to FIGS. 1 & 2 generally, and initially to FIG. 1, the apparatus 10 of the present invention may be provided with a heating pad 13 which may contain a heating element which may be molded into a high density polyethylene with, by way of non-limiting example, a maximum temperature of 103 degrees Fahrenheit. The heating pad 13 may be covered or enveloped by a removable liner 16 which may be washable if it should become soiled. The removable liner 16 may also enclose side guards 19 which may aid in preventing a baby or objects from rolling off of the apparatus 10.

The apparatus 10 may also contain a heating bag 22 which may be thermostatically controlled to warm pajamas, clothing, diapers, dry towels, or other objects. An interior of the heating bag 22 may be accessed by through a pocket opening 25.

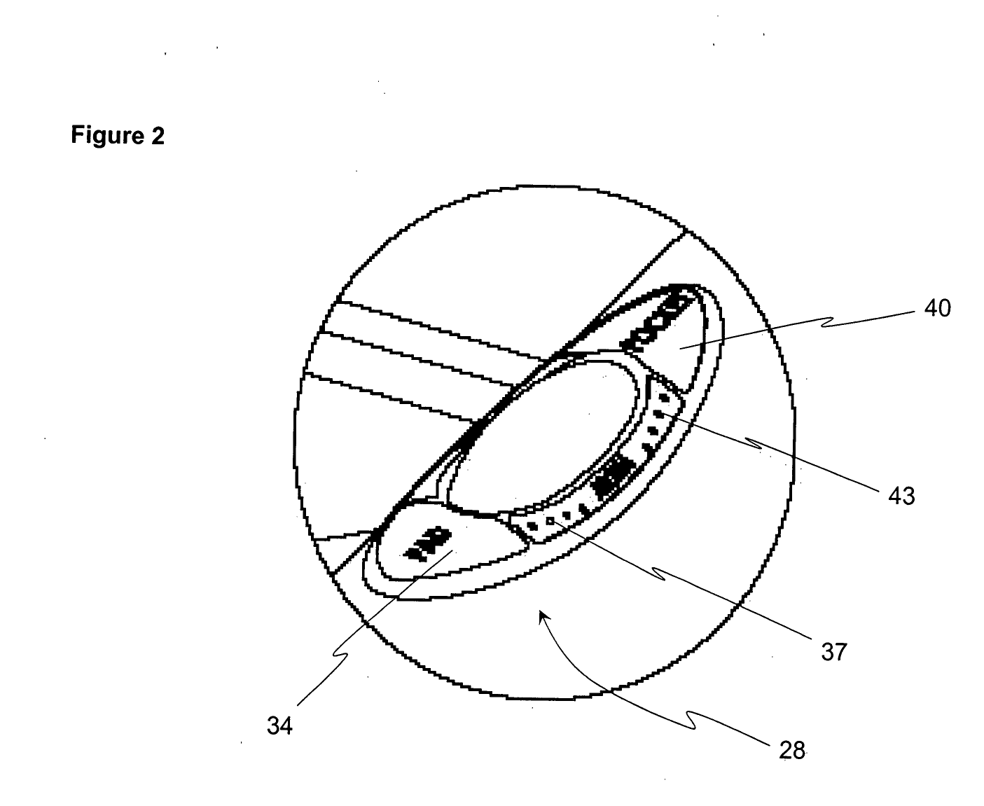

The temperature of the apparatus 10 is controlled by utilizing a feature control unit 28 which may have an auto on and off timer regulated by the user. The feature control unit 28 may have built-in circuitry to automatically shut it off if the temperature sensor fails to provide a correct value (i.e. is disconnected or breaks). As shown in FIG. 2, the feature control unit 28 may be provided with a heating pad adjustment button 34 capable of adjusting the temperature of the heating pad 13 between various settings which may be displayed on the heating pad indicator LEDs 37. Similarly, the feature control unit 28 may be provided with a heating bag 22 adjustment button 40 capable of adjusting the temperature of the heating bag 22 between various settings which may be displayed on the heating bag indicator LEDs 43.

In alternative embodiments of the invention, the feature control unit 28 may also include an aroma diffuser, a music playing device or a light.

In use, the apparatus 10 may be placed on a typical changing surface 31. Alternatively, the apparatus 10 may be placed on, by way of non-limiting example, a table, shelf or the ground.

In another embodiment of the invention, the apparatus 10 may be powered by a standard electrical outlet by means of a cord, or by batteries.

As another alternative, the present invention may be used to provide a warmed liner for a car seat, infant seat, or baby swing. Also, the present invention can be used on the ground in a larger version as a play area for a child.

While the invention has been described in connection with certain embodiments, it is not intended to limit the scope of the invention to the particular forms set forth, but, on the contrary, it is intended to cover such alternatives, modifications, and equivalents as may be included within the spirit and scope of the invention.

What is claimed is:

1. A combined changing pad/textile warming apparatus, comprising:
an elongate flexible member having a major surface with a first end and a second end, the first end of the flexible member having a pouch formed thereon;
a heating element disposed on the flexible member;
wherein the heating element provides heat to at least one of the major surface and the pouch.
